(19) United States
(12) Patent Application Publication
(10) Pub. No.: US 2007/0090965 A1
(43) Pub. Date: Apr. 26, 2007

(54) Key-fob locating method and apparatus

(76) Inventor: Clark E. Mc Call, Ann Arbor, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/255,738

(22) Filed: Oct. 21, 2005

(51) Int. Cl. G08B 1/08; G08B 5/22

(52) U.S. Cl. 340/825.49; 340/539.13

(57) ABSTRACT

Methods and apparatus are provided for obtaining information on the whereabouts of a vehicle key-fob. The apparatus comprises a transmitter, a receiver, a motion detector, memory, and a controller operatively coupled thereto. The controller uses instructions stored in the memory to operate the transmitter in response to a first signal provided by the motion detector indicating that the key-fob is in motion and a second signal provided by the receiver when the key-fob is in range of a communication node, to send thereto via the transmitter information useful in tracking the key-fob. The user interrogates the node to retrieve the location information deposited thereon by the key-fob. The stored information may be a time dated list of nodes the key-fob has visited or current position information generated within the key-fob itself and/or the nodes, or a combination thereof.

### TECHNICAL FIELD

The present invention generally relates to remote location of a movable object, and more particularly relates to method and apparatus for locating a vehicle key-fob.

### BACKGROUND OF THE INVENTION

Wireless remotes are widely used to control various functions of a vehicle, such as locking and unlocking the doors, engine start-stop, lights on-off and so forth. Such dedicated remote controls for vehicles are commonly referred to as “key-fobs” because they are usually configured to also be used as a key holder. As used herein, the words “key-fob”, singular or plural, are intended to include any type of vehicle remote control whether or not adapted to also hold keys.

One of the problems commonly encountered with key-fobs is that they are easily lost or misplaced. This is often due to their small size. For example, a person exits his or her vehicle with the key-fob, enters the house or office and casually drops the fob into a convenient receptacle or lays it on a cushion of the sofa or chair where it may slide out of sight or leaves it in a pocket of a jacket that is hung in a closet or dropped in the laundry. It may be hours or days before the key-fob is needed again, by which time the person may not remember exactly where it was placed. If the key-fob is not in plain sight, it may be very difficult to find. Accordingly, there is an ongoing need for a means and method that will aid in locating the key-fob. In addition, it is desirable to make use of available networks that may be present in the home or office to aid in the search. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

An apparatus is provided for obtaining information on the whereabouts of a key-fob. The apparatus comprises a transmitter, a receiver, a motion detector, memory, and a controller operatively linked thereto. The controller uses instructions stored in the memory to operate the transmitter in response to a first signal provided by the motion detector indicating that the key-fob is in motion and a second signal provided by the receiver when the key-fob is in range of a communication node, to send thereto via the transmitter information useful in tracking the key-fob. The user interrogates the node to retrieve the location information deposited thereon by the key-fob. The stored information may be a time dated list of nodes the key-fob has visited or current position information generated within the key-fob itself and/or the node, or a combination thereof.

A method is provided for obtaining information on the whereabouts of a key-fob. The method comprises, when the key-fob is in motion, forming an ad-hoc network with one or more communication nodes in its vicinity, storing on such communication nodes information related to the current position or the current and past position of the key-fob; and interrogating one or more of such communication nodes to obtain therefrom the information related to the current position or the current and past position of the key-fob. The stored information may be a time dated list of nodes the key-fob has recently visited or current position information generated within the key-fob itself and/or the nodes, or a combination thereof.

### DESCRIPTION OF THE DRAWINGS

The present invention will hereinafter be described in conjunction with the following drawing figures, wherein like numerals denote like elements, and

FIG. 1 is a simplified schematic diagram of the path of a key-fob according to the present invention in a illustrative situation outside a vehicle;

FIG. 2 is a simplified electrical schematic block diagram of a conventional prior art key-fob;

FIG. 3 is a simplified electrical schematic block diagram of a key-fob according to a first embodiment of the present invention;

FIG. 4 is a simplified electrical schematic block diagram of a key-fob according to another embodiment of the present invention;

FIG. 5 is a simplified electrical schematic block diagram of a wireless node for interacting with the key-fob of the present invention;

FIG. 6 is a simplified flow diagram illustrating the steps of a method of the present invention according to a first embodiment; and

FIGS. 7-8 are simplified flow diagrams illustrating the steps of a method of the present invention according to further embodiments and showing further details.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

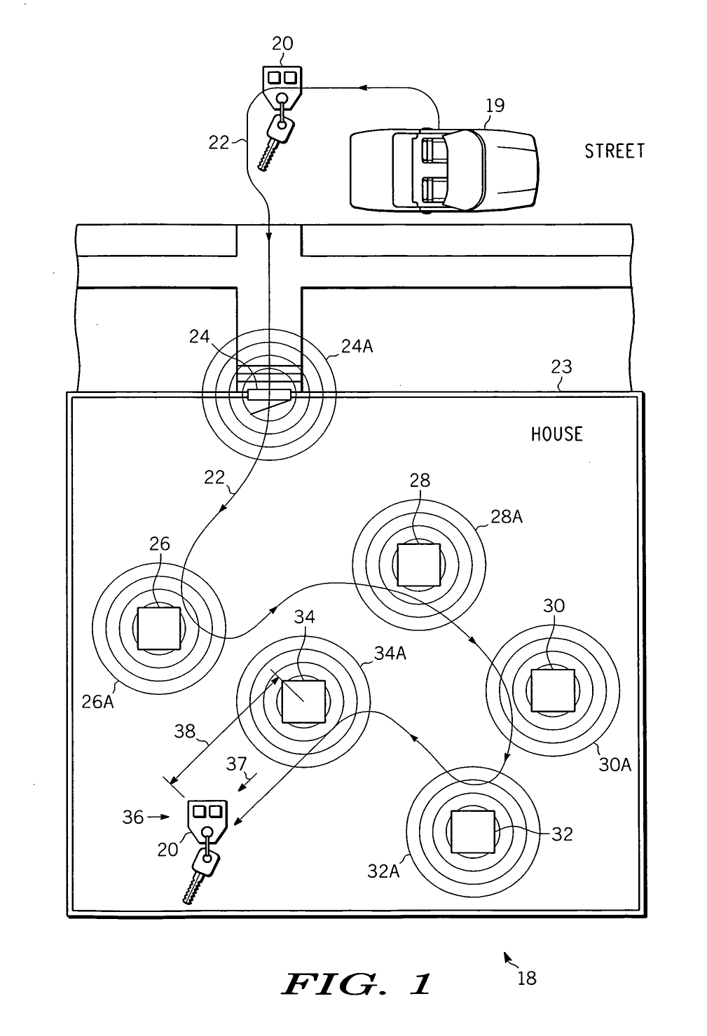

FIG. 1 is a simplified schematic diagram 18 showing key-fob 20 according to the present invention in an illustrative situation outside vehicle 19. Vehicle 19 is, for example, parked adjacent to house (or other building) 23. As key-fob 20 moves along path 22 it interacts with various communications nodes 24-34 associated with house 23. House 23 has, for example, entrance intrusion detector 24, refrigerator 26, dishwasher 28, telephone base station 30, clothes washer/dryer 32, computer 34 with a wireless local network, and so forth. For convenience of explanation, it is assumed that elements 24-34 are equipped with short range telecommunication capability as indicated by RF signal patterns 24A-34A, preferably network forming telecommunication capability such as provided by Bluetooth®, by IEEE 802.11 a, b, . . . g, etc., by IEEE802.15.4 (Zigbee) or other communication protocols. In FIG. 1, all of elements 24-34 are shown as being equipped with such RF signaling capability, but this is merely for convenience of explanation and is not essential. The present invention functions as long as one or more of such local elements has such RF signaling capability or equivalent.

In the present example, a user carrying his or her key-fob 20, exits vehicle 19 and moves along path 22 into house (or other building) 23, past various elements (e.g., communication nodes) 24-34 and finally drops the key-fob in location 36. For purposes of this example, it is assumed that the user is unable to recall where he or she dropped the key-fob and uses the present invention to assist in locating it. As key-fob 20 moves through house 23 past various communication nodes 24-34, it interacts with them in such a way as to leave an electronic trail of its whereabouts that can be later recalled in searching for and locating key-fob 20. For purposes of illustration and not intended to be limiting, key-fob 20 is assumed to have been left at location 36 which is in direction 37 at distance 38 from communication element or node 34.

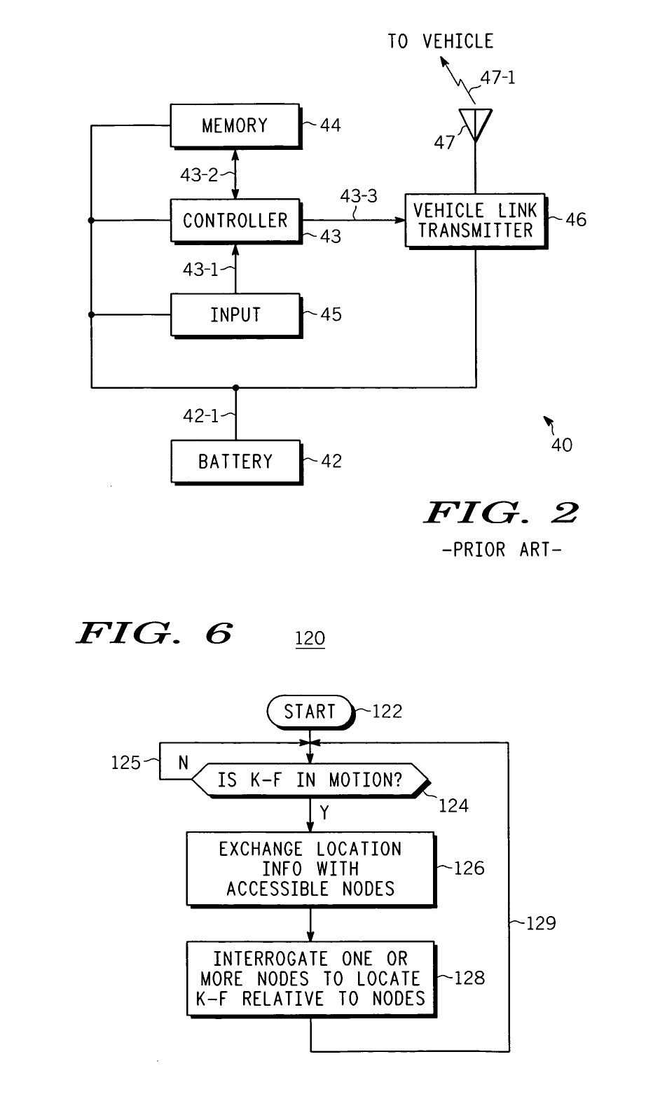

FIG. 2 is a simplified electrical schematic block diagram of conventional key-fob 40. Key-fob 40 comprises battery 42, controller 43, user input 45, memory 44, RF vehicle link transmitter 46 and antenna 47, interconnected as shown. The user depresses a switch on input 45 intended to send a particular action command (e.g., lock/unlock) to vehicle 19. This switch-push is sent via link 43-1 to controller 43. In response thereto, a coded transmission is formulated by controller 43 in cooperation with memory 44 interacting over link 43-2, and sent via link 43-3 to RF vehicle link transmitter 46 which broadcasts the coded transmission to a vehicle via link antenna 47 as shown by wireless signal 47-1. Vehicle link transmitter 46 operates typically at 315 MHz in the USA and Japan and 433 MHz in Europe. A receiver in the vehicle (not shown) captures this transmission and passes it along to the vehicle electronics system which executes the command. This is conventional. DC power is supplied to elements 43-46 from battery 42 over DC links 42-1.

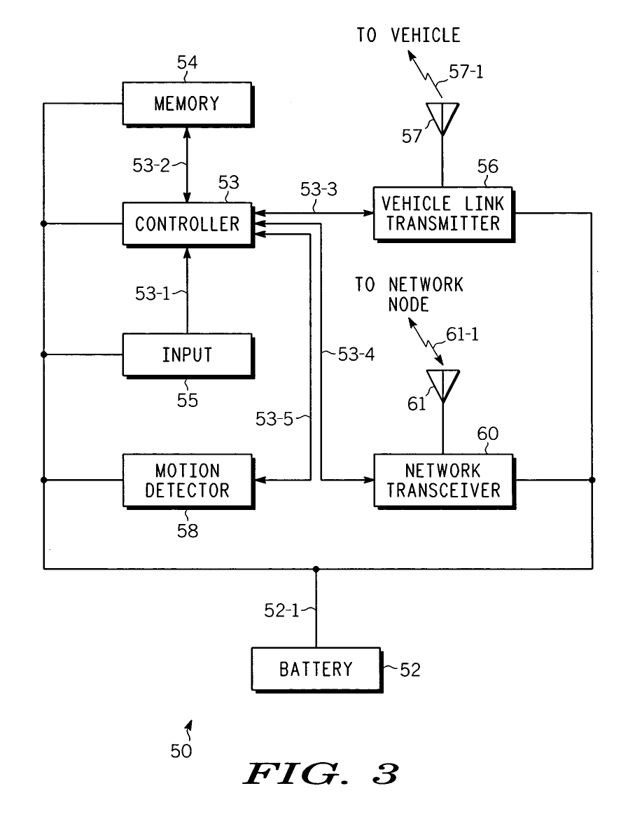

FIG. 3 is a simplified electrical schematic block diagram of key-fob 50 analogous to key-fob 20 of FIG. 1, according to a first embodiment of the present invention. Key-fob 50 conveniently has battery 52, controller 53, memory 54, input 55, RF vehicle link transmitter or transceiver 56 and antenna 57 coupled by links 53-1, 53-2 and 53-3 that perform at least functions similar to those provided by elements 42-47 and links 43-1, 43-2 and 43-3 of key-fob 40 of FIG. 2. Transmitter or transceiver 56 and antenna 57 provide wireless signal 57-1 and operate typically at 315 MHz in the USA and Japan and 433 MHz in Europe, although this is not essential. In addition, key-fob 50 comprises wireless network interface transceiver 60 coupled to processor 53 via link 53-4 and to antenna 61, and conveniently also motion detector 58 coupled to processor 53 via link 53-5. Any type of movement sensitive apparatus may be used for motion detector 58, but it is desirable that it consume no power when quiescent. A non-limiting example of a suitable arrangement is a simple circular spring mounted concentric to a pin or wire that passes freely through the center of the circular spring. When there is any significant motion of the key-fob, the spring deflects and the surrounding spring touches the pin or wire, thereby completing an electrical circuit. When motion stops, the surrounding spring returns to its quiescent position not touching the pin or wire. It draws no power unless activated.

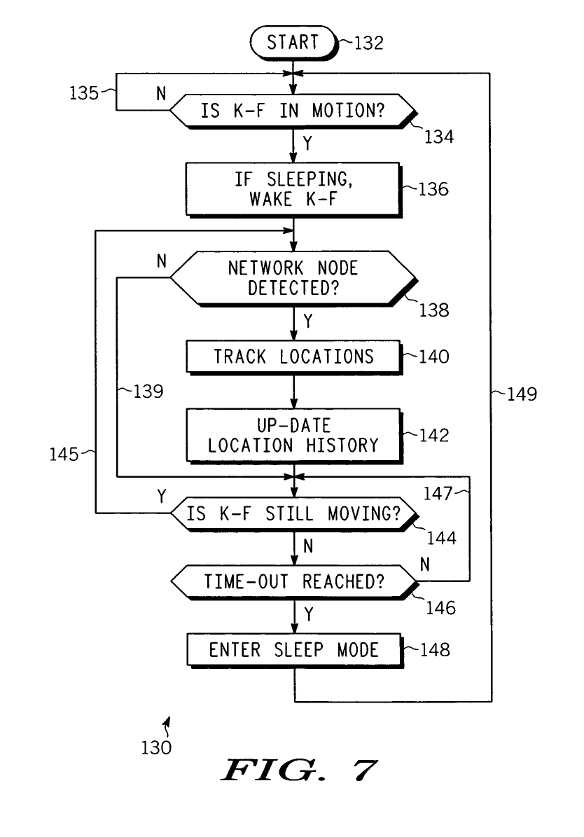

Transceiver 60 and antenna 61 desirably operate at the frequencies determined by the communication network nodes (e.g., nodes 24-34 of FIG. 1) with which they are intended to interact. As fob 50 comes within signaling range of various ones of nodes 24-34 (see FIG. 1) network interface transceiver 60 in cooperation with controller 53 establishes an ad-hoc network connection with such node according to the protocol that such node uses (e.g., Bluetooth®, IEEE 802.11 a, b, . . . g, IEEE802.15.4 (Zigbee), etc.) and stores its individual identification (ID) number on the node, preferably with the time and date at which it passed by such node. Thus, key-fob 50 leaves an electronic marker on the various nodes indicating that it passed by at a certain time and date. As used herein the words “time stamped” or “time dated” are intended to include both time and time plus date information. By doing this with every node with which it interacts during its trip along path 22 of FIG. 1, it leaves behind a record of its passage, a trail, a statement of “where it has been.” As will be subsequently explained in more detail in connection with FIGS. 6-8, this time stamped “where it has been” information is helpful in establishing the current location of key-fob 20 when the need arises. Inclusion of motion detector 58 is desirable since it can be used to keep key-fob 50 awake as long as it is in motion and allow it to be put to sleep to conserve battery energy after it has been motionless for a predetermined time, for example and not intended to be limiting, 10-30 minutes. In this way, as long as the user is carrying key-fob 50 and moving actively through house 23 (or any other place), key-fob 20 desirably remains active and leaves its time-stamped “footprint” on all of the nodes it passes. Once it has been placed somewhere and is no longer moving, key-fob 20 desirably goes to sleep, that is, goes dormant, after a predetermined interval. This significantly extends battery life. Energy to operate elements 53-60 of key-fob 50 is supplied by battery or other energy storage element 52 over DC links 52-1. As used herein, the word ‘battery’ is intended to include any form of electrical energy storage adapted to power a key-fob such as is described here and the word “house” is intended to include any building or space, indoors or outdoors, containing communication nodes with which the invented key-fob can interact.

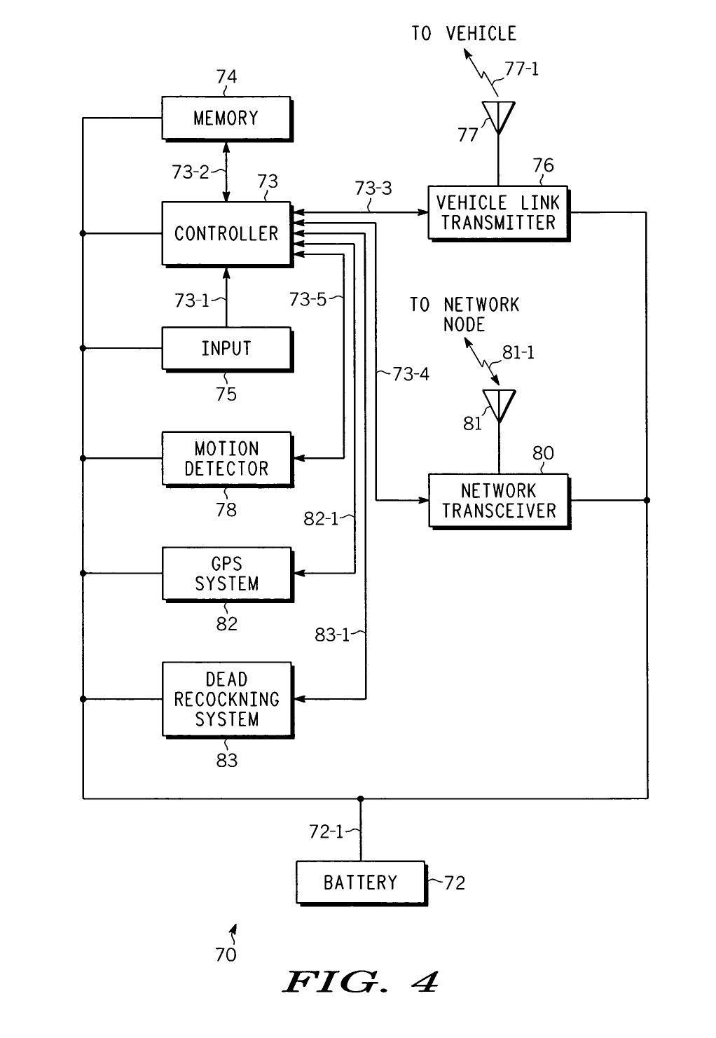

FIG. 4 is a simplified electrical schematic block diagram of key-fob 70 analogous to key-fob 20 of FIG. 1 but according to another embodiment of the present invention. Key-fob 70 comprises battery 72 coupled to the other elements by DC path 72-1, processor 73, memory 74, input 75, RF vehicle link transmitter or transceiver 76 with associated antenna 77, optional motion detector 78, and wireless network interface transceiver 80 with associated antenna 81, coupled variously via links 73-1, 73-2, 73-3, 73-4, in substantially the same manner as for key-fob 50 of FIG. 3. In addition, key-fob 70 comprises one or more elements 82, 83 coupled to controller 73 via links 82-2, 83-1 respectively. Element 82 is conveniently a GPS position locating element that in cooperation with controller 73 can determine the current three dimensional location coordinates of key-fob 70. Such GPS elements are currently commercially available. Element 83 is conveniently a dead-reckoning (abbreviated as “DR”) position estimator that, for example, in cooperation with controller 73 and memory 74 keeps track of the movements of key-fob 70 after it exits vehicle 19 (see FIG. 1). A “ped-o-meter”® type motion detector that measures the number of steps taken to provide distance information coupled to an electronic compass to provide direction or course information is an example of a.simple mechanism for element 83 that can be used for dead-reckoning (DR) course calculations by controller 73. Including one or both of GPS element 82 and/or DR element 83 allows key-fob 70 to continually estimate its position, and communicate this position information to any communication node (e.g., nodes 24-34) with which it can interact. Thus, while key-fob 50 provides information useful in determining its current location when lost by storing on the various nodes a list of the places where it has been, key-fob 70 is able to announce its current GPS position or DR position to any node with which it can currently communicate. Suppose for example, that house 23 is equipped with a PC based local network or other apparatus that substantially covers the whole house. Then the user can find his or her lost key-fob 70 by merely interrogating the PC which either provides the last known position of key-fob 70 before it went back to sleep or interrogates key-fob 70, wakes it up and receives a position up-date that it reports to the user. By reporting not only its current location, but also its recent location history (e.g., the nodes that it has most recently passed by and whose locations are precisely known), the task of finding it is much simplified even when the movement tracking information is not highly accurate. For example, suppose that key-fob 70 most recently passed by PC 34 (see FIG. 1), and its DR tracker says that it traveled an additional seven paces (e.g., distance 38) south-west (e.g., direction 37) of node 34. Since the location of PC node 34 is precisely known, any dead reckoning tracking errors up to that point do not matter and the current key-fob position can be determined with a high degree of accuracy even though dead-reckoning (DR) tracker 83 may have limited long range accuracy. While the above-described pace-counter and compass combination is useful for dead reckoning (DR) tracker 83, any arrangement capable of providing distance and direction information may be used.

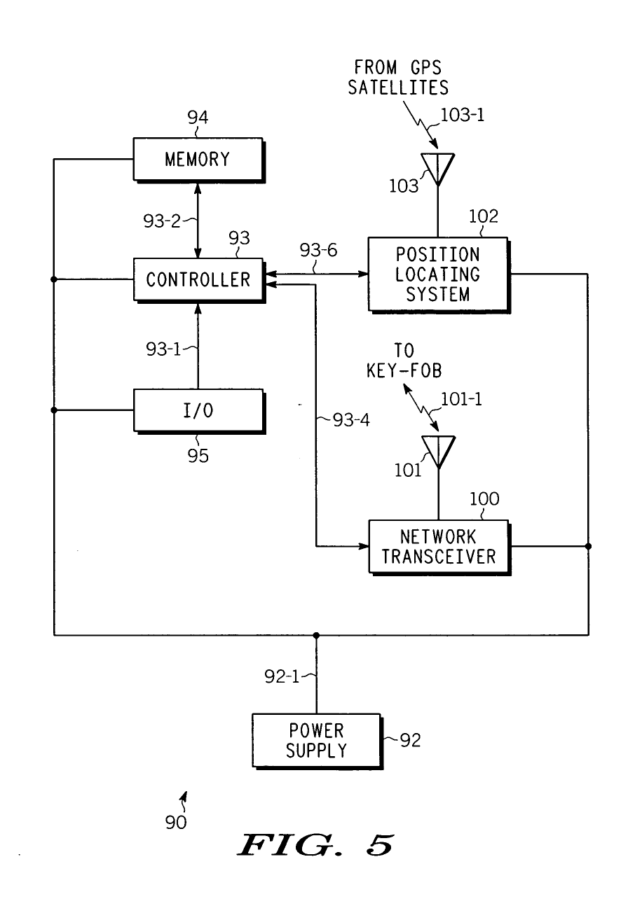

FIG. 5 is a simplified electrical schematic block diagram of wireless node 90 useful for interacting with key-fob 20, 50, 70 of the present invention. Wireless node 90 conveniently comprises power supply 92 DC coupled to the various elements by link 92-1, controller 93, memory 94 coupled to processor 93 via link 93-2, input or input-output 95 coupled to processor 93 via link 93-1, network transceiver 100 coupled to processor 93 via link 93-4 and to antenna 101, optional position locating element 102 (e.g. a GPS receiver) coupled to controller 93 via link 93-6 and to antennal 104. Network transceiver 100 in cooperation with controller 93 operates under the direction of programs stored in memory 94 according to the desired protocol (e.g., Bluetooth®, IEEE 802.11 a, b, g, IEEE802.15.4 (Zigbee), etc.). They establish a communication link with key-fob 20, 50, 70 when it comes within signaling range. Wireless node 90 receives from key-fob 20, 50, 70 its unique ID and stores that unique ID and current local time (and date) in memory 84. Node 90 may also, receive from key-fob 20, 50, 70 information on a predetermined number of the other nodes with which key-fob 20, 50, 70 has interacted prior to coming within signaling range of node 90 or within a predetermined time period prior to reaching node 90. Either arrangement is useful. In the case of key-fob 70, node 90 may also receive and store the current coordinates of key-fob 70, e.g., as determined by GPS system 82 or dead reckoning (DR) system 83 of key-fob 70. Node 90 may also, send to key-fob 20, 50, 70 its own coordinates as determined by position locating elements 102 (e.g., when node 90 is a moveable object like a personal digital assistant (PDA) or cell phone), or its predetermined location coordinates when node 90 is a fixed element (e.g., washer-dryer, refrigerator, desk-top PC, Hi-Fi, large TV, telephone base station, perimeter security system element, etc.). This allows dead-reckoning system 83 of key-fob 70 to zero-out any accumulated dead-reckoning tracking errors. Position locating element 102 is convenient where node 90 is a moveable object but is otherwise not essential. While a GPS receiver is useful for position determining element 102, it is not essential and any elements or arrangements that can provide the current location of moveable node 90 may also be used.

FIG. 6 is a simplified flow diagram illustrating the steps of method 120 of the present invention according to a first embodiment. Method 120 begins with START 122 and initial IS KEY-FOB IN MOTION ? query 124. For convenience of illustration, the words “key-fob” are abbreviated as “K-F”, the words “global positioning system” are abbreviated as “GPS” and the words “dead-reckoning” are abbreviated as “DR” in FIGS. 6-8 and elsewhere. If the outcome of query 124 is NO (FALSE), e.g., as determined by motion detector 58, 78, indicating that the key-fob is not moving, then method 120 returns to START 122 and initial query 124 as indicated by path 125. If the outcome of query 124 is YES (TRUE) then method 120 proceeds to step 126 in which key-fob 20, 50, 70 communicates and exchanges information with one or more of nodes 24-34, 90, that is, with those of nodes 24-34, 90 that come within range of key-fob 20, 50, 70, and tracks its location by proximity to the various nodes, and/or by GPS, dead-reckoning (DR) or a combination thereof. Key-fob 20, 50, 70 desirably leaves a record of its locations, that is, its present location and optionally also its immediate past location(s), on nodes 24-34, 90. When a user needs help in locating fob 20, 50, 70, then in step 128 one or more of the various nodes are interrogated. The interrogated node(s) then display or announces the fob location information stored thereon. For example, if node 32 (see FIG. 1) is interrogated, then node 32 reports that fob 20, 50, 70 passed by at whatever time and date is stored in its memory, and desirably, also displays or announces the prior travel history of the key-fob, that is, the time and date when it passed by nodes 24, 26, 28, 30, etc. (see FIG. 1). This information provides a memory aid to the user to assist in recalling where the key-fob was placed. Depending upon the nature of the node, it may also be able to provide more detailed information. For example, if node 34 is a PC with a house-wide local network with which fob 20, 50, 70 can communicate, then this node can interrogate key-fob 20, 50, 70 and obtain from the key-fob itself its travel history, that is, what nodes it passed, in what order and at what time-date. If the key-fob is equipped with a GPS or DR position locating system, then PC node 34 can interrogate key-fob 20, 50, 70 and directly obtain its current position at distance 38 (e.g., 4 paces, 10 feet, 3 meters, or whatever other units are desired) in direction 37 (e.g., south-west) from node 34. Alternatively, node 34 or any other node that capable of communicating with other nodes, can obtain the key-fob's travel history by interrogating such other nodes and reading the travel history that the key-fob has deposited on such other nodes. Either method provides information useful in helping to locate the key-fob. The key-fob location information can be provided to the user by the various nodes in visual form, audible form or a combination thereof. Method 120 then returns to START 122 and initial query 124 as shown by path 129. Nodes 24-34 can retain the key-fob location information they have stored until reset by the user either directly at the nodes or by a command issued to the nodes via the key-fob itself, or it can be automatically updated with new location information the next time the key-fob passes by, as determined by the system designer or user depending upon their needs. The present invention works even if the key-fob is asleep and consuming essentially no battery energy since the record of its passage can be determined from the nodes alone and this information can be provided to a user without the key-fob being awake. Alternatively if the key-fob has the capability, e.g., through on-board GPS or DR tracking, to monitor its own position, then if it is within communication range of a node, the node can awaken it, obtain this location information from the fob and announce it to the user. Either arrangement provides useful information to the user to assist in relocating the key-fob.

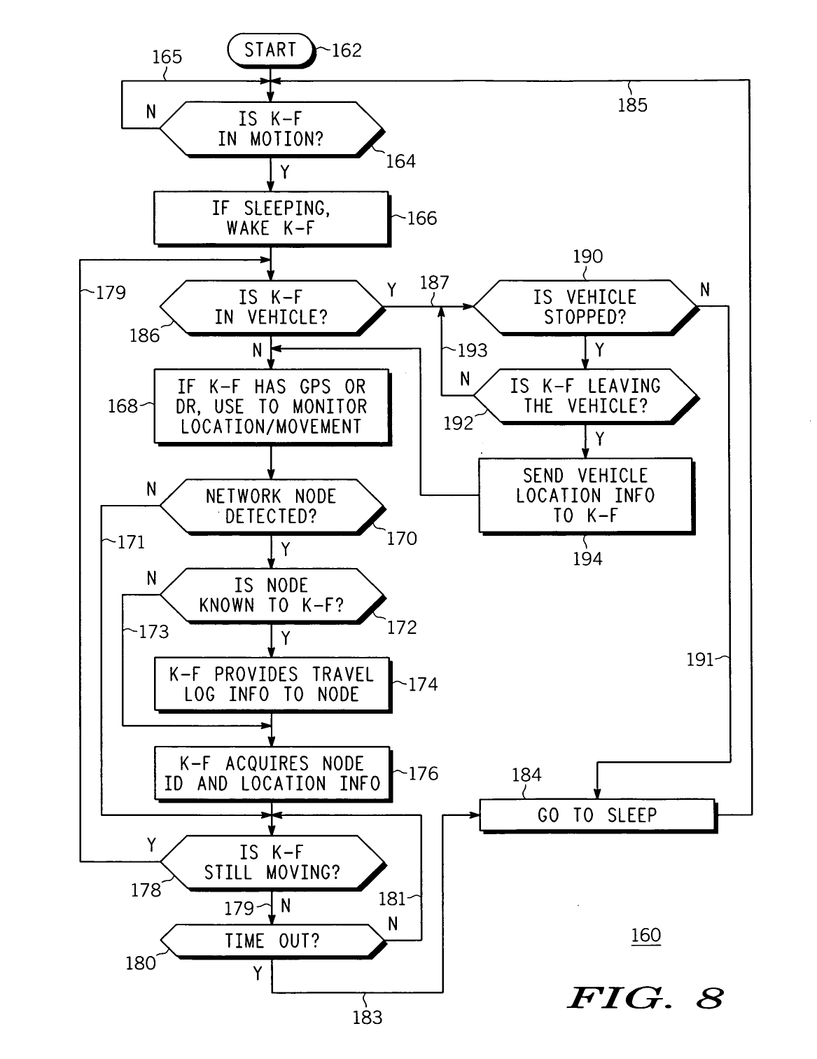

FIGS. 7-8 are simplified flow diagrams illustrating the steps of a method of the present invention according to further embodiments and showing further details. FIG. 7 which illustrates method 130 that begins with start 132 and “IS K-F IN MOTION ?” query 134 wherein it is determined, e.g., using motion detector 58, 78, whether or not key-fob 20, 50, 70 is moving. Motion detector 58, 78 is conveniently but not essentially of a type that uses no power while quiescent. If the outcome of query 134 is NO (FALSE) then method 130 returns to start 132 and initial query 134 as shown by path 135. If the outcome of query 134 is YES (TRUE) indicating that key-fob 20, 50, 70 is in motion, then method 130 proceeds to step 136 wherein if key-fob 20, 50, 70 is sleeping, i.e., in a dormant state, then it wakes up. Step 136 can occur automatically upon detecting a YES (TRUE) outcome of query 134, wherein the closure of a contact on motion detector 58, 78 causes key-fob 20, 50, 70 to come out of its sleep state and be fully active. In subsequent NETWORK NODE DETECTED ? query 138 it is determined whether or not there are any of nodes 24-34 in the vicinity of key-fob 20, 50, 70 with which key-fob 20, 50, 70 can form an ad-hoc network and exchange location information. If the outcome of query 138 is NO (FALSE) indicating that there are no available nodes within communication range of key-fob 20, 50, 70, then method 130 proceeds to IS K-F STILL MOVING ? query 144. If the outcome of query 138 is YES (TRUE) indicating that there are active nodes within communication range of key-fob 20, 50, 70, then in step 140, key-fob 20, 50, 70 receives ID and location info from the node(s) with which it is in contact. In step 142, key-fob 20, 50, 70 sends its ID location history to such node(s) so that the location path history stored on that node is updated. In the case of key-fob 70 that is capable of providing GPS and/or DR information about its current position, this information can also be passed to the node with which it is currently communicating and the known location of the current node passed back to key-fob 70 so that any accumulated DR errors may be corrected. In subsequent IS K-F STILL MOVING ? query step 144, it is determined whether or not key-fob 20, 50, 70 is still moving. If the outcome of query 144 is YES (TRUE) then method 130 desirably returns to query 138, and steps 138, 140, 142 and 144 repeated until a NO (FALSE) outcome results from query 144. When the outcome of query 144 is NO (FALSE) indicating that fob 20, 50, 70 has come to rest somewhere, then method 130 desirably proceeds to optional TIME OUT REACHED ? query 146 wherein it is determined whether or not the “NOT MOVING” state has lasted for a predetermined TIME OUT period. If the outcome of query 146 is NO (FALSE) indicating that the predetermined time out period has not yet elapsed, the method 130 returns to query 144 until key-fob 20, 50, 70 resumes moving or the predetermined time-out period expires. When the outcome of query 146 is YES (TRUE) indicating that the time-out wait period has expired, then method 130 proceeds to ENTER SLEEP MODE step 148 wherein key-fob 20, 50, 70 once again goes to sleep (i.e., goes dormant) and method 130 returns to START 132 and initial query 134 as shown by path 149.

FIG. 8 illustrates method 160 that begins with start 162 and “IS K-F IN MOTION ?” query 164 wherein it is determined, e.g., using motion detector 58, 78, whether or not key-fob 20, 50, 70 is moving. Motion detector 58, 78 is conveniently but not essentially of a type that uses no power while quiescent. If the outcome of query 164 is NO (FALSE) then method 160 returns to start 162 and initial query 164 as shown by path 165. If the outcome of query 164 is YES (TRUE) indicating that key-fob 20, 50, 70 is in motion, then method 160 proceeds to step 166 wherein if key-fob 20, 50, 70 is sleeping, i.e., in a dormant state, then it wakes up. Step 166 can occur automatically upon detecting a YES (TRUE) outcome of query 164, wherein the closure of a contact on motion detector 58, 78 can cause key-fob 20, 50, 70 to come out of its sleep state and be active in whole or part. Steps 164, 166 are analogous to steps 134, 136 of method 130 of FIG. 7. Returning again to FIG. 8, method 160 then proceeds to IS K-F IN VEHICLE ? query 186. If the outcome of query 186 is YES (TRUE) then method 160 proceeds to IS VEHICLE STOPPED ? query 190, as shown by path 187. If the outcome of query 190 is NO (FALSE) then as shown by path 191, method 160 proceeds to step 184 wherein the key-fob is returned to the sleep or dormant state and, as shown by path 185, method 160 returns to START 162 and initial query 164. If the outcome of query 190 is YES (TRUE) then method 160 proceeds to IS K-F LEAVING THE VEHICLE ? query 192 wherein it is determined whether or not the key-fob is exiting the vehicle. If the outcome of query 192 is NO (FALSE) then method 160 returns to query 190 as shown by path 193. If the outcome of query 192 is YES (TRUE) then method 160 proceeds to step 194 wherein the vehicle location information, determined for example, by the vehicles on-board GPS system, is sent to the key-fob.

Following step 194 or if the outcome of query 186 is NO (FALSE) and if key-fob 70 having GPS and/or DR tracking capability is being used, then step 168 is executed to monitor course and distance traveled by key-fob 70. If GPS and/or DR capability are not included in the key-fob being used, then method 160 proceeds to NETWORK NODE DETECTED ? query 170 analogous to query 138 of method 130 wherein it is determined whether or not there are any of nodes 24-34 in the vicinity of key-fob 20, 50, 70 with which key-fob 20, 50, 70 can form an ad-hoc network and exchange location information. If the outcome of query 170 is NO (FALSE) indicating that there are no available nodes within communication range of key-fob 20, 50, 70, then as shown by path 171 method 160 proceeds to IS K-F STILL MOVING ? query 178 analogous to query 144 of method 130. If the outcome of query 170 is YES (TRUE) indicating that there are active nodes within communication range of key-fob 20, 50, 70, then method 160 proceeds to optional IS NODE KNOWN TO K-F ? query 172 wherein it is determined whether or not the node ID and/or location encountered by key-fob 20, 50, 70 are previously known to key-fob 20, 50, 70, that is, do the ID and/or location just received from the node match an ID and/or location already stored in key-fob 20, 50, 70? It is desirable that the query test for both the node ID and the node location since there are some nodes that are moveable (e.g., cell phones, PDAs, etc.) where the ID may already be stored in the key-fob but whose location has changed. If the outcome of query 172 is NO (FALSE) indicating that the node ID or location or both are previously unknown, then as shown by path 173 key-fob 20, 50, 70 acquires the node ID and location info from the node in step 176. If the outcome of query 172 is YES (TRUE) indicating that the node is already known to the K-F, then method 160 proceeds to step 174. In step 174 the key-fob and node inter-communicate so that current location information and recent history stored in the key-fob are sent to and stored in the node. Method 160 then proceeds to step 176 wherein the current node's ID and location are desirably but not essentially sent to and stored in the key-fob.

On completion of step 176 or if the outcome of query 170 is NO (FALSE) then method 160 proceeds to IS K-F STILL MOVING ? query 178, analogous to query 144 of method 130 of FIG. 7. If the outcome of query 178 is NO (FALSE), then method 160 proceeds to optional timeout query step 180 via path 179 and returns via path 181 or proceeds to GO TO SLEEP step 184 via path 183 and back to START 162 via path 185 in much the same manner as already described in connection with steps 144, 146, 148 of method 130, which description is incorporated herein by reference. If the outcome of query 178 is YES (TRUE) indicating that key-fob 20, 50, 70 is still moving, then method 160 proceeds to IS K-F IN VEHICLE ? query 186 wherein it is determined whether or not key-fob 20, 50, 70 is in vehicle 19, e.g., did the user carry the key-fob back to the vehicle? The steps following query 186 have already been described and will be repeated as long as the key-fob is outside the vehicle and still moving, exchanging information with new nodes that come along while still moving. If the key-fob stops moving or re-enters the vehicle, then the key-fob will eventually go back to sleep even if the vehicle is moving, and method 160 will return to START 162 and initial query 164 waiting for the key-fob to move again independent of the vehicle, as has already been described. The effect of method 160 is to have key-fob 20, 50, 70 provide information on its whereabouts to nodes with which it can communicate as long as it is moving outside the vehicle or when interrogated by a node, and when no longer moving outside the vehicle, go back to sleep until re-awakened, even if the vehicle itself moves.

While at least one exemplary embodiment has been presented in the foregoing detailed description, it should be appreciated that a vast number of variations exist. Also, while the foregoing description has illustrated the invention in the context of vehicle key-fobs, those of skill in the art will understand that it applies to any moveable electronic device whose current location may be forgotten and whose user needs assistance in locating it from time to time. Accordingly, it is intended that the word “key-fob” singular or plural include any portable apparatus whose location needs to be tracked and/or whose path needs to be reconstructed. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A key-fob adapted to provide information on its whereabouts by interacting with one or more communication nodes having determinable location(s), comprising:
a transmitter;
a receiver;
a motion detector;
memory; and
a controller operatively coupled to the transmitter, receiver, motion detector and memory;
wherein the controller operates under the direction of instructions stored in the memory to operate the transmitter in response to a first signal provided by the motion detector indicating that the key-fob is in motion and a second signal provided by the receiver indicating that the key-fob is in communication range of one of the communication nodes, to send to such communication node via the transmitter information useful in tracking the whereabouts of the key-fob.

2. The key-fob of claim 1, further comprising:
a user input for receiving user commands;
a vehicle link transmitter; and
wherein the user input and the vehicle link transmitter are operatively coupled to the controller for sending such user commands to a vehicle.

3. The key-fob of claim 1, further comprising:
a GPS or a dead-reckoning system coupled to the controller for providing course and distance or location information to the controller as the key-fob moves, which course and distance or location information is passed to the communication node via the transmitter.

4. The key-fob of claim 1, wherein the controller operates under the direction of instructions stored in the memory to operate the receiver in response to the first signal provided by the motion detector indicating that the key-fob is in motion and the second signal provided by the receiver indicating that the key-fob is in communication range of one of the communication nodes, to receive from such communication node via the receiver further information useful in tracking the whereabouts of the key-fob and storing such further information in the memory.

5. The key-fob of claim 4, wherein the further information received from the communication node includes information on the location of such communication node.

6. The key fob of claim 5, wherein the controller causes the location of successive communication nodes with which the key-fob exchanges information to be stored in the memory and reported to subsequent communication nodes encountered by the key-fob.

7. The key-fob of claim 1, wherein the motion detector is adapted to draw no power when the fob is not in motion.

8. The key-fob of claim 1, further comprising:
a user input coupled to the controller adapted to receive from the user various commands desired to be executed by an associated vehicle; and
a vehicle link transmitter coupled to the controller adapted to send such commands to the associated vehicle.

9. The key fob of claim 8, further comprising:
a vehicle link receiver coupled to the controller and adapted to receive location information from the associated vehicle for storage in the memory.

10. A method for determining at least in part the location of a key-fob, comprising:
detecting when the key-fob is in motion;
providing location history information concerning the key-fob to one or more communication nodes that come within communication range of the key-fob; and
interrogating the one or more communication nodes to obtain therefrom the location history information concerning the key-fob stored thereon.

11. The method of claim 10 further comprising:
determining when the key-fob is no longer in motion; and
after a predetermined time of no longer being in motion, causing the key-fob to enter a sleep mode.

12. The method of claim 10 further comprising following the detecting step, if the key-fob is in a sleep mode, awakening it.

13. The method of claim 10 wherein the providing step includes providing fob location information developed internally within the fob.

14. A method for determining the location of a key-fob, comprising:
when the key-fob is in motion, forming an ad-hoc network with one or more communication nodes in its vicinity;
storing on such communication nodes information related to the current position or the current and one or more past positions of the key-fob; and
interrogating such communication nodes to obtain therefrom the stored information related to the current position or the current and one or more past positions of the key-fob.

15. The method of claim 14, wherein the step of forming an ad-hoc network occurs when the key-fob is in motion outside a vehicle.

16. The method of claim 14, further comprising:
when the key-fob is moving, obtaining course and distance or location information and reporting such information to such communication nodes.

17. The method of claim 16, wherein the obtaining step comprises generating the course and distance or location information internally within the fob.

18. The method of claim 14, wherein the step of forming an ad-hoc network when the key-fob is in motion, comprises, prior to forming the ad-hoc network:
detecting when the key-fob is in motion; and
if the key fob is sleeping, awakening the key-fob.

19. The method of claim 18 further comprising after the awakening step:
determining if the key-fob is in a vehicle; and
if it is in a vehicle, determining if the vehicle is moving; and
if the vehicle is moving, returning the key-fob to a sleep mode.

20. The method of claim 19, further comprising:
if the vehicle is not moving, determining if the key-fob is leaving the vehicle; and
if the key-fob is leaving the vehicle, sending vehicle location information to the key-fob.
